(19) United States
(12) Patent Application Publication
(10) Pub. No.: US 2014/0319842 A1
(43) Pub. Date: Oct. 30, 2014

(54) Device for Recovering Energy from a Moving Fluid

(71) Applicant: GEPS INNOV, Saint-Nazaire (FR)

(72) Inventor: Mathieu Barsacq, Nantes (FR)

(73) Assignee: GEPS INNOV, Saint-Nazaire (FR)

(21) Appl. No.: 14/357,594

(22) PCT Filed: Nov. 9, 2012
(86) PCT No.: PCT/EP2012/072315

§ 371 Date: May 12, 2014

(30) Foreign Application Priority Data
Nov. 10, 2011 (FR) 1160238

(51) Int. Cl. F03B 13/10; F03D 3/02; F03D 9/00; F03D 3/00

(52) U.S. Cl. CPC F03B 13/10; F03D 3/005; F03D 3/02; F03D 9/002
USPC 290/55; 290/54

(57) ABSTRACT

A device for recovering energy from a moving fluid includes at least one first turbine and at least one second turbine with each mounted between a first guiding element and a second guiding element and with the guiding elements being shifted in relation to one another in a first direction that is perpendicular to the direction of flow of the fluid, and with each of the guiding elements being generally streamlined in shape. The second turbine is shifted in relation to the first turbine in a second horizontal direction that is parallel to the direction of flow, and in the first direction such that the first or the second guiding element of the first turbine is positioned in the first direction between the two guiding elements of the second turbine.

### BACKGROUND

This invention relates to a device for recovering energy from a moving fluid in an open environment. The invention has a particular application in the field of wind and marine current energies.

Currently, designers of wind and marine current turbines seek to improve the output of their installations by focusing on improving the individual performance of each of the wind and marine current turbines or through an approach in terms of magnitude by increasing the number or the size of the latter in order to reduce the proportion of the fixed costs in the cost of the kilowatt/hour produced.

The collecting of wind turbine energy is however limited by physical phenomena. More precisely, Albert Betz has shown that the maximum theoretical power that can be recovered by a wind turbine is equal to 16/27 of the incident power of the wind that passes through the wind turbine. This limit is conventionally called the Betz limit.

Moreover, the visual impact and the encumbrance on the surface of wind or marine current farms also constitute hindrances in increasing the size of these systems.

Wind turbines arranged at sea in offshore farms, which are conventionally horizontal axis of rotation wind turbines, also have other disadvantages in relation to land wind turbines, namely:
in the case of floating structures, the length of the blades must also be limited due to the dynamic movements of the structure that could generate devastating accelerations for the wind turbine;
wind turbines must be sufficiently spaced between them in order to limit the effects of wake.

With regards to marine current turbines, they are currently arranged in a fixed manner at the bottom of the water and also have the following disadvantages:
their diameter must be reduced in order to limiter hindrance to the surface navigation;
as with wind turbines, they must also be sufficiently spaced between them in order to limit the effects of wake.

A first general principle of the solutions exposed here is based on the arrangement of at least two turbine sets oriented along the axis of the flow of fluid considered, in such a way that at least a portion of the flow passing through the set of upstream turbines combined with the flux along the extrados of the guiding elements is directed towards the turbines of the set arranged downstream and contribute to the acceleration of the flow penetrating into the downstream turbines.

To this effect, this invention proposes a device for recovering energy from a moving fluid comprising at least two turbines with substantially parallel axes of rotation coupled to at least one alternator in order to produce electrical energy when the fluid in movement drives in rotation said turbines, characterised in that:
each turbine is mounted between a first guiding element of flow and a second guiding element of flow in a first direction, perpendicular to the direction of displacement of the flow of fluid, with each of the guiding elements being generally streamlined in shape,
and in that this device comprises at least one first turbine and at least one second turbine which is arranged downstream of the first turbine in a second direction parallel to the direction of displacement of the flux, said second turbine is shifted in the first direction, in such a way that the first and/or the second guiding element of flow of the first turbine is positioned in the first direction between the two guiding elements of the second turbine.

A second general principle of the solutions exposed here is based on the following considerations:

The current arrangements (see examples FIGS. 9, 10) of multiple wind turbines and marine current turbines are designed in such a way that:
the flow concerning each turbine 50 is optimised by the use of one or several annular fairing(s) 52 (FIG. 9), with a horizontal, or vertical axis of rotation 51 with each in the shape of a wing (FIG. 10), with a vertical axis of rotation 510, and each with a typically convex inner edge 520,
the interactions between the different turbines are as minimal as possible.

Moreover, the complete studies carried out in particular in two theses: AUMELAS September-2012 and MENCHACA-2011 relate to vertical fairings for vertical axis turbines. A marked characteristic is the convexity on the turbine side, i.e. the inner side of the fairing.

The objective of these accessories is to contribute to a flow such as shown in FIG. 11. According to the hypotheses of Weler, or of Hansen (“Aerodynamics of wind Turbine”), the effectiveness of turbines provided with fairing(s) or an appendix or appendices increases in proportions from 2 to 5 and makes it possible to exceed in output the Betz limit of 59%.

Moreover, it can be considered that WO 2011/049843 discloses a device for recovering energy from a moving fluid comprising at least one first and at least one second turbines with substantially parallel axes of rotation and coupled to at least one alternator in order to produce electrical energy when the fluid in movement drives in rotation said turbines, with the, or each, second turbine being, in relation to the or each first turbine:
shifted in a first direction (Z) perpendicular to the direction (F) of the flow of fluid,
and arranged downstream in a second direction (X) parallel to the direction of the flow.

However, it so happens that the global output of the installation with the turbines arranged over several upstream/downstream ranks depends on their relative positioning, and in particular on the organisation of the aforementioned appendices or fairings, referred to hereinafter as “guiding elements”.

### SUMMARY

It is as such proposed:
that each turbine be mounted, in said first direction (Z), between a first and a second guiding elements of flow, each generally streamlined in shape,
that the device comprise at least two second turbines shifted in relation to one another in the first direction (Z), in such a way that the first guiding element of the, or each, first turbine is positioned in the first direction (Z) between the two guiding elements of one of the second turbines and that the second guiding element of the, or each, first turbine be positioned in the first direction (Z) between the two guiding elements of flow of the other second turbine,
and that the first and/or the second guiding element of flow of the, or each, first turbine be positioned in the first direction (Z) between the two guiding elements of each second turbine.

More preferably, this in fact will be a multi-stage and multi-rank device, with guiding elements of axis (substantially) perpendicular to the axis of the turbines (with a substantially horizontal chord for vertical axis turbines), which have for function to create a “brake” comprised of the first rank of turbine(s), which, associated with the guiding elements shown in particular in FIGS. 1 and 12 herewithin, contributes to a notable improvement in the performances of the next rank(s).

In this framework, an aspect of this invention has for purpose to propose a solution aimed at overcoming all or a portion of the aforementioned disadvantages and in particular to improve a global output of collecting the kinetic energy of fluids in movement in an open environment, by exceeding in output the Betz limit of 59%, and this when more than one turbine is at stake, i.e. in the case where at least one turbine influences another turbine, due to the passage through the first turbine of a portion at least of the flow of fluid received by the second.

In liaison with this, it is recommended that the guiding elements favourably have a convex profile on the side opposite the turbine, at least for the first rank, even, more preferably, for the outer guiding element of each second turbine (the lowest of the second rang), with therefore a convex extrados.

More preferably, the aforementioned “first direction” (Z) will be a vertical direction, although a horizontal orientation is possible.

In background art, streamlined shape means a three-dimensional shape of which the transversal section comprises a leading edge located upstream of the profile in relation to the flow, a trailing edge located downstream in relation to the flow, connected via an extrados surface located on the outer side in relation to the turbine and an intrados surface, located on the inner side in relation to the turbine.

The guiding elements will for example be fins having a profiled section in the direction of the flow and a large size in the case of elements of the “wing” type, or a diameter in the case of elements of the “lens” type. In both cases, the chord of the section is defined as the line joining the centre of curvature of the leading edge and the centre of curvature of the trailing edge of the profile. For fins of the “wing” type the largest dimension corresponds to the span and the aspect ratio corresponds to the ratio between the span and the length of the chord. In the case with an element of the “lens” type the guiding element is defined by its section and its diameter of revolution.

Surprisingly, the inventors discovered during the testing that this particular arrangement of a second turbine provided with guiding elements, in relation to a first turbine provided with guiding elements, makes it possible to obtain increased rotating speeds for second turbines. These tests showed that the rotating speed of the second turbine is at least 1.5 times greater than that of the first turbine, and can be up to 3 times greater than that of the first turbine.

It has been shown that with streamlined guiding elements of flow that have convex extrados as indicated hereinbefore, the fluid (in particular a liquid) passing, in the case of a vertical “first direction” (Z), above and below these extrados of the first turbine (or series of turbines) is accelerated on these convex outer surfaces, which concentrate and accelerate the flow of incoming fluid from the second turbine (or series of turbines). This accelerated fluid on the extrados draws the fluid exiting from the first turbine before supplying the second turbines, which has for effect to reduce the global loss of load of the device (see flow as a dotted line in FIG. 12).

Note that the expressions “turbines shifted in relation to one another” or “turbine arranged downstream” of another, aim to indicate that these turbines have between them (with D being the diameter of the turbines, as shown in particular in FIG. 1):
according to the direction X parallel to the flux, a distance X1 (FIGS. 2, 4) between about 1D and environ 5D (to the nearest 20%), to obtain a sought effect of wake,
and/or, according to the direction Y perpendicular to the flux (horizontal in the figures hereinafter), a profile that can be continuous (aircraft wing) and be used as a support structure for the turbines, with, in any case, a distance between environ 1D and environ 5D (to the nearest 20%), for the same effect of wake, with the liaisons even able to be continuous, as in FIG. 5 hereinafter,
and/or, according to the direction Z (vertical direction, or parallel to the axis of rotation of the turbines), a possible arrangement substantially side by side via their guiding elements of flow, then without a separation other than functional, benefitting if possible from a slot effect, even if a separation up to about 0.5D is possible, without however being desired.

Concerning the relative thicknesses between the turbines and the guiding elements of flow that surround them, it is preferred that that there are:
according to the direction X parallel to the flux, a dimension X2 of the guiding elements (FIG. 1) between environ 0.5 D and about 1.5 to 2D (to the nearest 20%), and/or,
according to the direction Y: a dimension Y2 of these elements between about 2D and about 4D (to the nearest).

According to the direction Z, it is moreover recommended that the thickness Z2 of said profiles (see example in FIGS. 2, 4) not be greater than 0.5 D (to the nearest 20%). Otherwise there is a risk of having profiles that would themselves act as brakes, without procuring any effect of acceleration but rather an increase in the drag by the vortex effect.

As such, it must be understood that a “first turbine” will favourable influence a “second” (or other) turbine” placed in its wake, due to the passage through the first turbine of a portion at least of the flow of fluid received by the second.

It is specified that the distances X1 between the ranks, for example 1 and 2 (FIGS. 2, 4) and 2-3 (FIG. 4) can vary (the same applies for Y, and even Z).

According to an embodiment, said second turbine is furthermore shifted in relation to the first turbine in a third direction, perpendicular to the first direction and to the second direction. In this case, the first turbine advantageously has a guiding element with a sufficient aspect ratio in order to have a portion arranged upstream of the second turbine in the second direction.

According to an embodiment, said device comprises at least two second turbines shifted in relation to one another in the first direction, in such a way that the first guiding element of the first turbine is positioned in the first direction between the two guiding elements of a second turbine and that the second guiding element of the first turbine is positioned in the first direction between the two guiding elements of flow of the other second turbine.

Advantageously, the second turbines have guiding elements of flow placed side by side, the two said guiding elements forming an intermediate guiding element, in one or two portions, with a surface constituting an inner guiding surface for a second turbine and a surface constituting an inner guiding surface for the other second turbine.

In the case of a first vertical direction, and of vertical axis turbines, the axial rods of the two second turbines are advantageously coaxial.

According to an embodiment, the guiding elements forming the intermediate guiding element of the second turbines are arranged in the first direction substantially mid-way between the two guiding elements of the first turbine, in such a way that the flow exiting from the first turbine is distributed in substantially equal shares between two second turbines.

According to an embodiment, the guiding elements of the first turbine on the one hand and the guiding elements of the second turbine or turbines on the other hand are arranged in such a way as to be superimposed partially in the first direction, in such a way as to in particular reduce the total encumbrance of the device.

According to an embodiment, the device comprises at least two second turbines shifted in relation to one another in the third direction, the first and second guiding elements of the first turbines extending in their largest dimension more preferably in the third direction between the two first turbines, advantageously the guiding elements of the first turbines are formed from the same part.

According to an embodiment, a first turbine is positioned in the third direction between two second turbines shifted in relation to one another in said third direction.

According to an embodiment, the device comprises at least two first turbines shifted in relation to one another in the third direction, the first and second guiding elements of the first turbines extending in their largest dimension more preferably in the third direction between the two first turbines, advantageously the guiding elements of the first turbines are formed from the same part.

According to an embodiment, each second turbine is positioned in the third direction between two first turbines shifted in relation to one another in said third direction.

According to an embodiment, the device comprises at least one third turbine shifted in relation to a first turbine in the second direction, in such a way that the third turbine is arranged downstream of the second turbine in relation to the direction of displacement of the flow of fluid, said third turbine having more preferably a positioning in the first direction substantially identical to that of said first turbine.

According to an embodiment, the device comprises at least one first turbine, at least four second turbines arranged in two superimposed rows of two second turbines, and at least one third turbine, with the turbines of a row being shifted from one another in the third direction. According to an embodiment, it comprises at least one row of two or several first turbines, at least two superimposed rows of two or several second turbines and at least one row of two or several third turbines.

According to an embodiment, said first guiding element and/or said second guiding element of the first turbine has a convex extrados according to the chord of the guiding element, in such a way as to further optimise the acceleration of the fluid that is displaced in the vicinity of said extrados.

Advantageously, the guiding elements are of the “wing” type, with leading and trailing edges shifted from one another in the second direction, and extending in their largest dimension substantially parallel to the third direction.

According to an embodiment, for each turbine, the guiding elements positioned facing each other have intrados of a substantially convex shape in such a way that the leading edges and the trailing edges of the two guiding elements respectively form a convergent portion in order to concentrate the incoming flow in the turbine and a divergent portion contributing to distribute the flow exiting from the turbine better.

Moreover, the intrados or inner surfaces can have a convexity in the third direction, in particular in the case of horizontal axis turbines.

The inner surfaces can have a convexity that is not as substantial as the extrados or outer surfaces. The inner surfaces can form a substantially planar intrados, with only end portions, of the inclined or convex type forming a convergent portion and a divergent portion, connected together by substantial planar central portions.

As such, according to an embodiment, for each turbine, the inner surface of the two guiding elements of flow comprises a substantial planar central portion, with the central portions of the two guiding elements being substantially parallel to each other.

According to an embodiment, each turbine further comprises two additional guiding elements, of a streamlined shape, shifted from one another in the third direction, arranged perpendicularly to the aforementioned guiding elements.

Advantageously, the turbines are mounted on a support structure. According to an embodiment of the invention, the support structure is able to be oriented automatically, in a natural or forced manner, in such a way that the second direction is substantially parallel to the direction of the flow.

According to an embodiment, said device is a marine device, comprising a floating offshore structure and anchored to the seabed at one or several points, or a fixed offshore structure, comprising turbines of the wind and/or marine current type.

According to a particular embodiment, the support structure provided with turbines is floating and the device comprises at least two sets of turbines each comprising a first turbine and two second turbines such as defined hereinabove, a first set of turbines being arranged above the waterline of the support structure and a second set of turbines being arranged below the waterline of the support structure. The turbines of the first set are driven by air and the turbines of the second set are driven by water. Advantageously, the immersed portion and the non-immersed portion of the structure are more preferably decoupled in order to allow for at least one relative rotation around the vertical direction, in such a way that each set of turbines is oriented independently to one another in relation to its flow.

According to another embodiment, said device is a land device.

According to an embodiment, the support structure comprises vertical risers to which are assembled the guiding elements of flow of the turbines.

According to an embodiment, each guiding element of flow is generally tapered shaped, with the central portion of the inner surface being circular and the upstream and downstream end portions being formed by an inclined annular portion extending radially from the periphery of the circular central portion. In the case of a first direction which is vertical, and vertical axis turbines, for each turbine, the centre of the circular central portion of the guiding elements of flow of the turbine can be located on the vertical axis of the axial rod of said turbine. As such, the turbine provided with its two guiding elements of flow has an axis of revolution corresponding to said vertical axis, allowing it to then operate optimally regardless of the angle of incidence of the incoming flow.

According to a particular embodiment, the device of the invention comprises at least two sets of turbines. Each set of turbines comprises a first turbine and two second turbines such as defined hereinabove. Said sets of turbines are shifted angularly in relation to one another on the support structure. Advantageously, the first turbines are arranged according to a first circle and the second turbines are arranged according to two second circles of the same radius shifted in the first direction, for example vertically. Advantageously, the angle separating two consecutive sets of turbines is constant in order to confer a character of revolution to the device.

### BRIEF DESCRIPTION OF THE DRAWINGS

The invention shall be better understood, and other purposes, details, characteristics and advantages shall appear more clearly when reading the following detailed explanatory description, by referring hereinbelow to the annexed drawings, among which:

FIG. 1 shows a diagrammatical top view of a device according to a first embodiment of the invention;

FIG. 2 shows a diagrammatical side view of the device of FIG. 1;

FIG. 3 shows a diagrammatical view of the side of the first turbine of the device of FIGS. 1 and 2;

FIG. 4 shows a diagrammatical view of the side of a device according to a second embodiment of the invention;

FIG. 5 shows a diagrammatical perspective view of the device of FIG. 4;

FIG. 6 shows a diagrammatical top view of the device of FIGS. 4 and 5;

FIG. 7 shows a diagrammatical top view of a third embodiment;

FIG. 8 shows a diagrammatical side view of the device of FIG. 7,

FIGS. 9, 10, 11 show solutions of prior art and,

FIGS. 12, 13 each show a diagrammatical side view of an alternative embodiment of the solution of FIG. 1.

### DETAILED DESCRIPTION

According to the invention, the device for recovering energy comprises at least two sensors of kinetic energy of fluid mounted on a support structure. These sensors of kinetic energy of fluid are vertical axis or horizontal axis turbines. These turbines are driven in rotation by the fluid in movement of an open environment, which can for example be air or water. Each turbine is mounted between two guiding elements of flow streamlined in shape, arranged in such a way that the chord of the section of the streamlined shape is substantially parallel to the direction of the flow, and shifted vertically or horizontally from one another. The turbines and their guiding elements of flow are arranged in relation to one another in order to improve the global performance of the device.

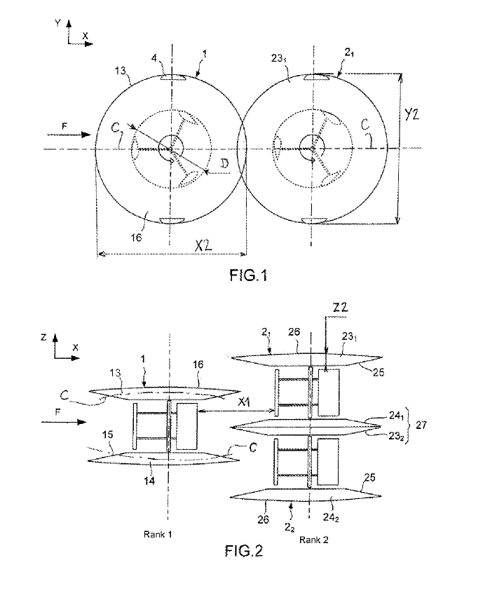

According to a first embodiment of the invention shown by the FIGS. 1 to 3, the device comprises three turbines 1, 21 and 22 mounted on a support structure shown partially in FIG. 1 under the reference 4. These turbines are coupled to at least one alternator (not shown) in order to produce electrical energy when the fluid in movement drives in rotation the turbines, said alternator being for example installed inside a guiding element. In this embodiment, the turbines are with a vertical axis.

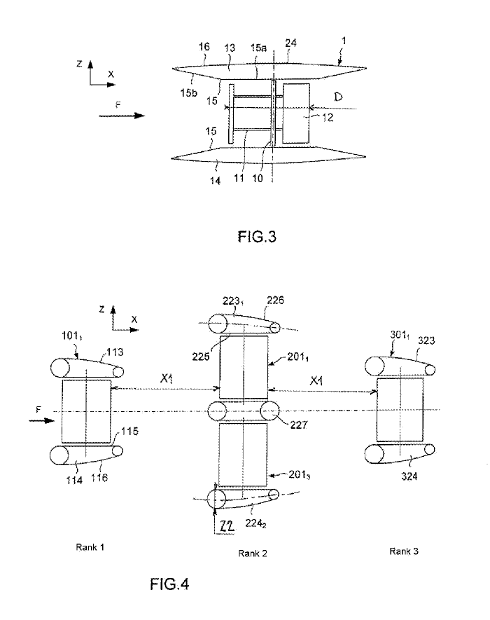

In reference to FIG. 3, the first turbine 1 comprises a vertical axial rod 10 and blades 12 connected to the axial rod by the arms 11. Each blade streamlined in shape creates a lift that, when the fluid flowing through the turbine is in movement, generates a rotating movement of the axial rod and thus drives the alternator by suitable means. Each turbine comprises more preferably at least two blades.

The first turbine 1 comprises two guiding elements of flow, namely a first upper guiding element of flow 13 and a second lower guiding element 14, shifted vertically in a first vertical direction Z, and between which is mounted the axial rod. These guiding elements are of the “lens” type and are arranged on either side of the turbine in such a way that their respective chords are substantially parallel and perpendicular to the first direction Z. They have an intrados 15 to guide the flow towards the blades of the turbine and an extrados 16. The intrados 15 of the guiding elements 13 and 14 are facing each other.

In the embodiment shown, the guiding elements are generally tapered shape. The extrados 16 corresponding to the large surface or large planar base of the truncated cone has a convex shape. The intrados 15 comprises a central portion 15a, planar and circular, corresponding to the small surface or small base of the truncated cone and an inclined annular portion 15b extending radially outwards from the circular central portion and corresponding to the lateral surface of the truncated cone. The annular inclined portions of the two guiding elements facing each other as such form, according to the direction F of the flow, a convergent portion and a divergent portion. The sections of annular portions facing each other arranged upstream of the turbine in relation to the direction of the flow F form a convergent portion in order to guide and accelerate the incoming fluid towards the turbine, and the sections of annular portions facing arranged downstream of the turbine form a divergent portion in order to distribute the flow exiting from the turbine better.

The second turbines 21, 22 include like the first turbine 1 a vertical axial rod and blades, for example in the number of three, connected to the axial rod by the arms. Each second turbine 21, 22 is also mounted by its axial rod between an upper guiding element 231, 232 and a lower guiding element 241, 242, shifted vertically, and between which is mounted the axial rod. These guiding elements are streamlined and have an intrados 25 in order to guide the flow towards the blades of the turbine and an extrados 26. The second turbines 21, 22 are stacked on each other, and are shifted in relation to the first turbine in the second horizontal direction X, which is parallel to the direction F of the flow, in such a way that the second turbines are positioned downstream of the first turbine in relation to the direction F of the flow, with the rods of the first turbine and of the second turbines being arranged substantially in the same vertical plane, with the rods of the second turbines being substantially aligned.

A second upper turbine 21 is mounted above the other second lower turbine 22. The guiding elements are as previously generally tapered shaped, with an intrados 25 having annular portions forming a convergent portion and a divergent portion. The extrados 26 of the upper guiding element 231 of the upper turbine and of the lower guiding element 242 of the lower turbine are also of convex shape. The second upper turbine 21 is mounted above the second lower turbine 22 in such a way that the lower guiding element 241 of the upper turbine is placed side by side with the upper guiding element 232 of the lower turbine. The extrados of said guiding elements 241, 232 are substantially planar and are placed side by side. Said guiding elements 241, 232 constitute an intermediate guiding element 27, advantageously formed of a single part.

The first turbine 1 and the second turbines 21, 22 are mounted on the support structure in such a way that the upper guiding element 13 of the first turbine is arranged vertically in the direction Z between the guiding elements 231 and 241 of the second upper turbine and that the lower guiding element 14 is arranged vertically between the guiding elements 232, 242 of the second lower turbine.

When the fluid circulates in the direction F, the first turbine 1 is present upstream of the two second turbines 21 and 22. The fluid driving the first turbine and existing from the latter, passes for a portion in the second upper turbine 21 and for another portion in the second lower turbine 22. The guiding elements 241 and 232 are advantageously arranged vertically mid-way between the two guiding elements 13 and 14 of the first turbine, in such a way that the flow exiting from the first turbine is supplied in shares substantially equal to the two second turbines. The fluid passing above and below the first turbine is accelerated on the outer surface or extrados 16, of the guiding elements 13 and 14. The convexity of the outer surfaces 16 makes it possible to increase the acceleration of the fluid circulating in the vicinity. This accelerated fluid on the extrados draws the fluid exiting from the turbine 1 before entering into the second turbines 21, 22.

Advantageously, the guiding elements of the first turbine on the one hand and the guiding elements of flow of the two second turbines on the other hand are arranged in such a way as to overlap partially in the horizontal direction X. This arrangement participates in reducing the encumbrance of the device in a horizontal plane.

Moreover, the centre of the circular central portion of the guiding elements of each turbine is advantageously located on the vertical axis of the axial rod of the turbine. The turbine provided with two guiding elements as such defined has a rotation symmetry, with the axis of revolution corresponding to the axis of the axial rod. The turbine then operates optimally regardless of the angle of incidence of the incoming flow.

As shown partially in FIG. 1, the guiding elements of flow of each turbine are fixed to two vertical risers 4, arranged for example symmetrically in relation to the axis of the axial rod of the turbine. The device comprises two risers 4 whereon are fixed the guiding elements of flow 13 and 14. It comprises two other risers whereon are fixed the guiding elements 231, 241, 232, 242. These vertical risers are streamlined to disturb the flow the least possible.

A device comprising a single set of three turbines has been described in reference to FIGS. 1 to 3. According to another embodiment, the device comprises a plurality of sets of first turbine and second turbines such as described hereinabove. These sets can be juxtaposed next to one another in the direction Y, and/or behind each other in the direction X. These sets can also be stacked on one another vertically in columns in the direction Z. The device can also include sets of at least three turbines, for example a set comprising two first turbines stacked on each other and three second turbines also stacked on each other, with the first two turbines being arranged upstream of the three second turbines.

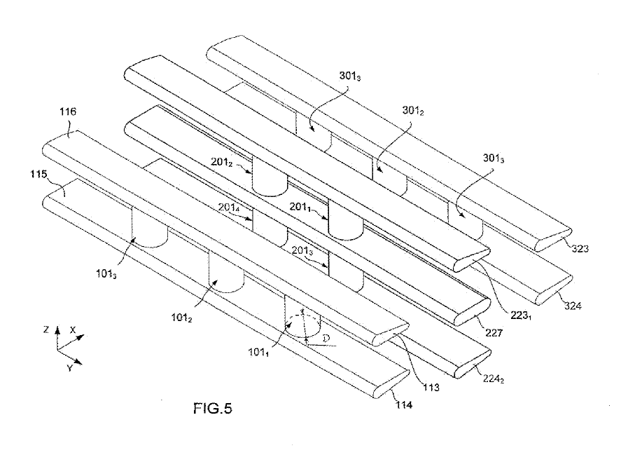

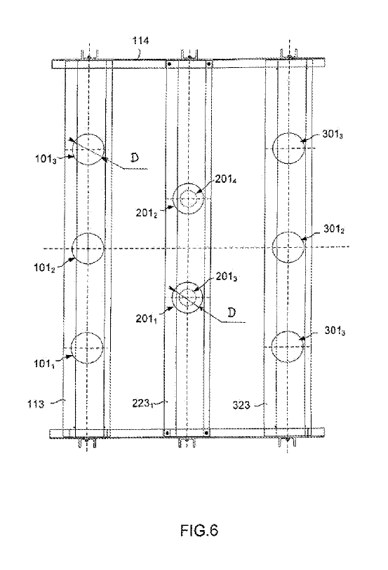

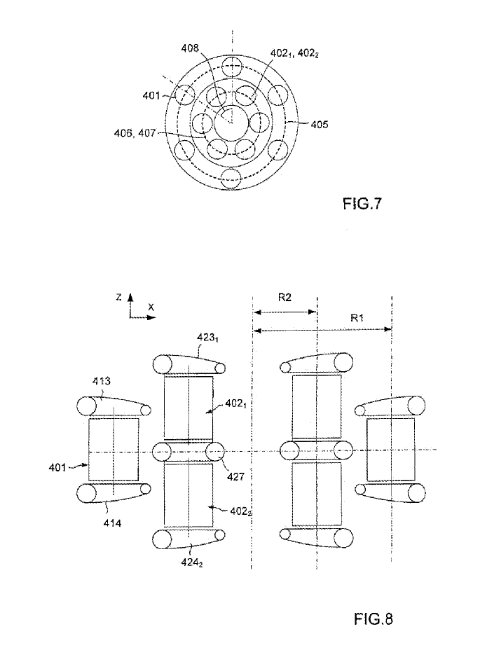

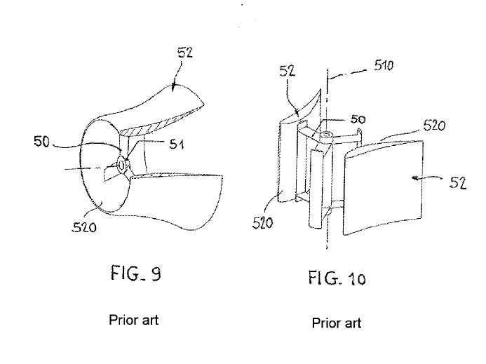

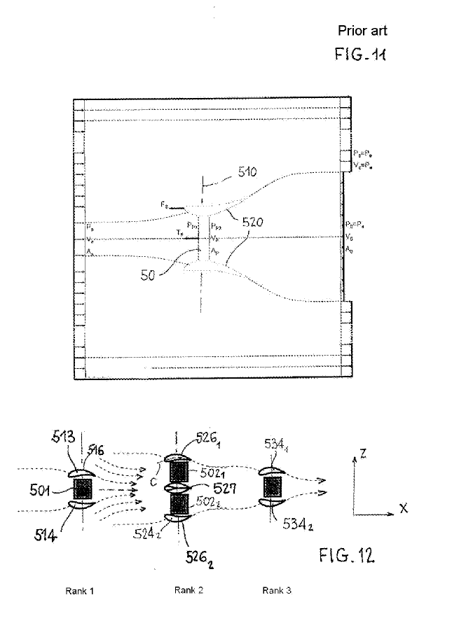

FIGS. 4 to 6 show a device according to a second embodiment according to the invention. The device, for example of the marine current turbine type comprises a row of three first turbines 1011, 1012, 1013, four second turbines 2011, 2012, 2013, 2014 arranged in two superimposed rows of two second turbines, and a row of three third turbines 3031, 3032, 3033. In this embodiment the first and second turbines are arranged in such a way that each second turbine is shifted in relation to a first turbine in the first vertical direction Z and in the second horizontal direction X, as well as in the third horizontal direction Y which is perpendicular to the direction F of the flow.

In the row of first turbines, the first turbines are shifted from one another in the direction Y.

Two second upper turbines 2011, 2012, of an upper row are shifted from one another in the direction Y and two second lower turbines 2013, 2014, of a lower row are shifted from one another in the direction Y. The two lower and upper rows are arranged one on top of the other in the direction Z, with an upper turbine arranged above a lower turbine, substantially without a shift between them in the direction Y, and are shifted in the direction X in relation to the row of the first turbine in such a way that the second turbines are arranged downstream of the first turbines in relation to the direction F of the flow. The two rows of second turbines are furthermore shifted in the direction Y in relation to the first turbines, in such a way that each second turbine is arranged between two first turbines in the direction Y, and are shifted in the direction Z in relation to the row of first turbines, in such a way that the second upper turbines are shifted upwards in the direction Z in relation to the first turbines and the second lower turbines are shifted downwards in the direction Z in relation to the first turbines.

In the row of third turbines, the third turbines are shifted from one another in the direction Y. This row is only shifted in the direction X in relation to the row of first turbines in such a way that the third turbines are arranged downstream of the second turbines in relation to the direction F and that each third turbine extends substantially in the extension of a first turbine

The first turbines are mounted between a common upper profiled section 113 and a common lower profiled section 114 constituting respectively the upper guiding elements of flow and the lower guiding elements of the first turbines. The upper and lower profiled sections extend according to their largest dimension in the third direction Y, and have a transversal section of the “wing” type, with an outer surface 116 or extrados, of convex shape of the leading edge until the trailing edge, and a substantially planar inner surface 115 or intrados. The leading edge and the trailing edge of each profile are shifted from one another in the second direction X. The profile has a convex leading edge of which a portion forms a convergent portion in order to guide the flow towards the first turbines. The profile has a convex trailing edge of which a portion forms a divergent portion in order to guide the flow at output of the first turbines.

In a similar manner, the second upper turbines 2011, 2012 are mounted between an upper common profiled section 2231 and a common intermediate profiled section 227, constituting respectively their upper guiding elements and their lower guiding elements. The second lower turbines 2013, 2014 are mounted between said intermediate profiled section 227 and a lower profiled section 2242, constituting respectively their upper guiding elements and their lower guiding elements.

The upper profiled section 2231 and the lower profiled section 2242 have substantially the same shape as the profiles 113, 114 of the first turbines, and have convex extrados and intrados substantially planar with leading edges and trailing edges forming respectively convergent portions and divergent portions. The intermediate profiled section 227 has an upper surface and a lower surface substantially planar with a leading edge and a convex trailing edge.

The third turbines 3031, 3032, 3033 are mounted between an upper profiled section 323 and a lower profiled section 324, in the same way as the first turbines.

The turbines are mounted via the ends of the respective profiles to a support structure 104, in such a way that the chords of the upper profiled sections 113, 323 of the first turbines and of the third turbines are positioned in the direction Z substantially between the upper profiled section 2231 and the intermediate profiled section 227 of the second upper turbines, and that the lower profiled sections 114, 324 of the first turbines and of the third turbines are positioned in the direction Z between the intermediate profiled section 227 and the lower profiled section 2242 of the second turbines.

Each turbine can furthermore include two vertical profiled sections arranged substantially perpendicularly to the guiding elements of flow, shifted from one another in the direction Y, constituting additional guiding elements of flow. These vertical profiled sections are advantageously mounted between the upper and lower guiding elements of flow, with a vertical profile able to be common to two adjacent turbines of the same row.

According to a third particular embodiment, the device of the invention shown in FIGS. 7 and 8 comprises a plurality of sets of first turbine 401 and second turbines 4021, 4022 such as defined hereinabove, said sets of turbines being shifted angularly in relation to one another on the support structure, the first turbines being arranged according to a first circle 405 of radius R1 and the second upper and lower turbines being arranged according to two other circles 406, 407, of radius R2<R1, shifted vertically, said circles of radius R1 and R2 being concentric. The angle 408 separating two consecutive sets of turbines is advantageously constant in order to confer a character of revolution to the device. In this embodiment, the guiding elements of flow of the first turbines of the device are formed from two first concentric streamlined rings 413, 414 shifted vertically and substantially of the same inner and outer radiuses, with the first turbines 401 being mounted between these two first rings. For each first turbine, the portion or section of the ring 413 which is above said turbine constitutes the upper guiding element and the portion or section of ring 414 which is below said turbine constitutes the lower guiding element. Likewise, three second rings 4231, 427, 4242, having a radius less than the first rings, are provided to respectively from the guiding upper and lower elements of the second turbines. The second upper turbines 4021 are mounted between a second upper ring 4231 and a second intermediate ring 427, while the second lower turbines 4022 are mounted between said second intermediate ring 427 and a second lower ring 4242.

The tests in circulation tunnel consisted in emerging the complete structure (shown in FIGS. 4 to 6), into a flow of homogenous fresh water of speed V. The rotating speeds of each turbine were recorded. These tests showed that the rotating speed of the second turbines is at least 1.5 time greater than that of the first turbines, and can be up to 3 times greater than that of the first turbines, and that the rotating speed of the third turbines is at least 1.4 times greater than that of the first turbines, and can be up to 2.5 times greater than that of the first turbines.

Although the invention has been described in liaison with different particular embodiments, it is obvious that it is not in any way limited to this and that it comprises all of the equivalent techniques of the means described as well as their combinations if the latter fall within the scope of the invention.

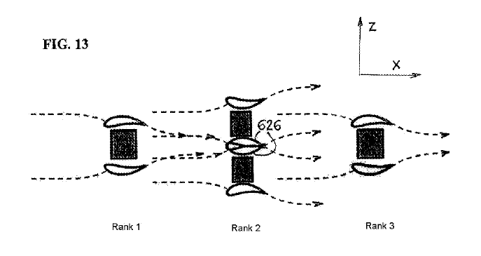

FIGS. 12, 13 but this applies in other cases, such as that of FIG. 1, the arrangement shown generates a flow that is significantly accelerated for the turbines of ranks 2 and 3.

The objective achieved was to withdraw the maximum power for a tube of fluid in a given movement.

This can result in the fact of having replaced a large turbine of which the output cannot exceed 59% and having a substantial environmental impact (disturbing) with an organised and calculated juxtaposition of several smaller turbines, more preferably identical, provided with guiding elements described hereinabove in order to achieve a global output exceeding 59% in relation to a reference tube of fluid in movement, and this all the more so if the fluid is a liquid.

FIG. 12, as such shows a multi-stage (axis Z, at least for the rank 2) and multi-rank (axis X) device, with guiding elements 513, 514, 5242, 5341, 5342 with axis perpendicular to the axis of the vertical axis turbines (horizontal for turbines such as 501), as here.

The first rank of turbines, with its convex extrados guiding elements (516, 5261, 5262), has for effect to create a “brake”, which, associated with the guiding elements shown therefore as a vertical cross-section in particular in FIGS. 1 and 12, contributes to a notable improvement in the performance of the following ranks.

With the arrangement described and shown and this convexity of the side opposite the turbine (therefore as extrados), for the (each) turbine of rank 1 and, more preferably, at least for the outer guiding element (surfaces 5261, 5262 FIG. 12) of each second turbine (turbines of rang 2, here 5021, 5022), has a (26, 226, etc.), this will generate the flow shown as a dotted line in FIG. 12 or 13 (which also exists in particular in the case of FIG. 1) and which is significantly accelerated for the turbines of ranks 2 and 3.

As such, it was possible to achieve a global output higher in output than the aforementioned Betz limit of 59% in relation to a reference tube of fluid in movement, by withdrawing the maximum power for a given tube of fluid in movement.

In the solution of FIG. 12, the intrados (which is still located on the turbine side) is concave; it could be substantially flat; as in FIG. 13, for:
turbines not interposed vertically between two others (ranks 1 and 3, in the examples shown)
and/or the end turbines, respectively the highest and the lowest, for the “multi-stage” ranks (rank 2 shown), being stated that, for the latter, one could be led to invert the profiles, i.e. convex intrados as shown in FIG. 13.

Note that, for the “intermediate” guiding elements, here rank 2 (that with stacked turbines), a symmetrical profile with a double upper/lower convexity, marked 626 FIG. 13 (see also FIG. 12), can usefully be provided between the turbines stacked parallel to the axis of rotation of these turbines (here therefore vertically).

1.-14. (canceled)

15. A device for recovering energy from a moving fluid comprising:
at least one first turbine and
at least one second turbine, wherein each turbine has a substantially parallel axis of rotation and are coupled to at least one alternator in order to produce electrical energy when the fluid in movement drives in rotation the turbines, and wherein
each turbine is mounted between a first guiding element of flow and a second guiding element of flow in a first direction (Z) perpendicular to the direction (F) of the flow of fluid, with each of the guiding elements being generally streamlined in shape,
and the second turbine is arranged downstream of the first turbine in a second direction (X) parallel to the direction of the flow, the second turbine being shifted in the first direction in such a way that the first and/or the second guiding element of flow of the first turbine is positioned in the first direction (Z) between the two guiding elements of the second turbine.

16. A device for recovering energy from a moving fluid comprising:
at least one first turbine and
at least one second turbine, wherein each turbine has a substantially parallel axis of rotation and coupled to at least one alternator in order to produce electrical energy when the fluid in movement drives in rotation the turbines, wherein the, or each, second turbine being, in relation to the or each first turbine shifted in a first direction (Z) perpendicular to the direction (F) of the flow of fluid, and arranged downstream in a second direction (X) parallel to the direction of the flow, such that each turbine is mounted, in the first direction (Z), between a first and a second guiding element of flow, each guiding element being generally streamlined in shape, wherein
at least two second turbines are shifted in relation to one another in the first direction (Z), in such a way that the first guiding element of the, or each, first turbine is positioned in the first direction (Z) between the two guiding elements of one of the second turbines and the second guiding element of the, or each, first turbine is positioned in the first direction (Z) between the two guiding elements of flow of the other second turbine, and
the first and/or the second guiding element of flow of the, or each, first turbine is positioned in the first direction (Z) between the two guiding elements of each second turbine.

17. The device according to claim 15 wherein each second turbine is shifted in relation to the first turbine in a third direction (Y), perpendicular to the first direction (Z) and to the second direction (X).

18. The device according to claim 17, wherein a first turbine is positioned in the third direction (Y) between two second turbines shifted in relation to one another in said third direction (Y).

19. The device according to claim 17, further comprising at least two first turbines shifted in relation to one another in the third direction (Y), wherein the first and second guiding elements of the first turbines extending in their largest dimension in the third direction (Y) between the two first turbines.

20. The device according to claim 17, wherein each second turbine is positioned in the third direction (Y) between two first turbines shifted in relation to one another in said third direction Y.

21. The device according to claim 15, further comprising at least one third turbine shifted in relation to a first turbine in the second direction (X), in such a way that the third turbine is arranged downstream of the second turbine in relation to the direction (F) of displacement of the flow of fluid, the third turbine having a position in the first direction (Z) substantially identical to that of said first turbine.

22. The device according to claim 17, further comprising at least four second turbines arranged in two superimposed rows of two second turbines, and at least one third turbine, with the turbines of one row being shifted from one another in the third direction (Y).

23. The device according to claim 15, wherein each turbine further comprises two additional guiding elements, of streamlined shape, shifted from one another in the third direction (Y).

24. The device according to claim 15, further comprising a floating offshore structure anchored to the seabed at one or several points, or a fixed offshore structure, comprising wind and/or marine current turbines.

25. The device according to claim 15, wherein the turbines are immersed in such a way as to be driven by water.

26. The device according to claim 1, wherein
The first and second guiding elements of the first turbine has a convex extrados, and/or
at least the outer guiding element of each second turbine has a convex extrados.

27. The device according to claim 1, wherein the device comprises at least two second turbines shifted in relation to one another in the first direction (Z), in such a way that the first guiding element of the first turbine is positioned in the first direction (Z) between the two guiding elements of a second turbine and that the second guiding element of the first turbine is positioned in the first direction (Z) between the two guiding elements of flow of the other second turbine.

28. The device according to claim 1, wherein the device comprises at least two second turbines shifted in relation to one another in the third direction (Y), the first and second guiding elements of the first turbines extending in their largest dimension in the third direction between the two first turbines.
